(19) United States
(12) Patent Application Publication
(10) Pub. No.: US 2002/0112033 A1
(43) Pub. Date: Aug. 15, 2002

(54) Content enhancement system and method

(76) Inventors: Marcus F. Doemling, Lake Hiawatha, NJ (US); Peter J. Matsuo, Troy, NY (US)

Correspondence Address: HOFFMAN WARNICK & D'ALESSANDRO, LLC, 3 E-COMM SQUARE, ALBANY, NY, 12207

(21) Appl. No.: 09/924,808

(22) Filed: Aug. 8, 2001

Related U.S. Application Data
(60) Provisional application No. 60/223,921, filed on Aug. 9, 2000.

(51) Int. Cl. G06F 15/16

(52) U.S. Cl. 709/219; 709/203

(57) ABSTRACT

A system and method for enhancing content downloaded to client. Included is an enhancement mechanism that can be transferred to a client along with a web page or other web resource. The enhancement mechanism causes content to be retrieved and output in an enhanced fashion at the client.

The current application claims priority to co-pending provisional application serial No. 60/223,921, filed on Aug. 9, 2000.

### BACKGROUND

1. Technical Field

The present invention relates to the enhancement of media content, and more particularly relates to the real-time enhancement of content on the world wide web without requiring customization.

2. Related Art

The proliferation of the internet and world wide web (hereinafter “web”) has created a great demand for effective content. After all, content is the key element that drives people to a website, or conveys a message about a product or service. Content comes in many forms, including text, graphics, audio, video, multimedia, etc. Numerous applications exist where content is being served over the web to clients.

In the web environment, content is typically embedded “indirectly” in web pages downloaded from a host server to a client. In particular, the web page will generally include a uniform resource locator (URL) that tells the client's browser where to retrieve the content from. The browser, upon analyzing the web page, will send a request out to the identified location(s), and the content will be returned and inserted in the web page at a predetermined location. Often, the content will reside on a third-party content server.

In many cases, it is much more efficient to store content on a content server, particularly where the content is going to be reused or changed on a frequent basis. To further improve efficiency, content is often developed in a standard format (e.g., size and protocol) that allows it to be easily plugged-in to existing web pages. Unfortunately, standardized content limits the overall creativity that can be presented in a web page. Moreover, quality content is often expensive to produce due to the artistic and technical requirements, as well as other costs.

One such example involves graphical advertising content, such as banner ads, branded content, etc. (hereinafter collectively referred to as “banner ads”), which have become a critical mechanism for generating revenue on the web. Such banner ads typically provide a graphically-displayed sign and information relating to a product, service or company. These banner ads may also provide a hypertext link to a related web page. Companies placing banner ads, as well as the websites that show them, generally get paid based on the number of hits associated with the ad, or more indirectly, based upon the effectiveness of the branding message. Accordingly, the process of getting people to notice an ad, and in some cases to follow the ad's link, has become an important and highly competitive process.

A banner ad may comprise an advertisement that typically runs across a web page or is positioned in a margin or other space reserved for ads. Common forms of banner ads are GIF (Graphics Interchange Format) images/movies, and so called rich media content, which may consist of several HTML components and images. In addition to adhering to predefined spatial dimensions, many web sites limit the size of the file to a certain number of bytes so that the file will display quickly. The most common larger banner ad is currently 468 pixels wide by 60 pixels high (i.e., 468×60). Other banner ad sizes include 300×250, 250×250, 240×400, 336×280, 160×600, 125×125, and 120×90 pixels. These and other banner sizes have been established as standard sizes by the Internet Advertising Bureau (IAB), and are described in more detail at <http://www.iab.net/iab_banner_standards/bannersource.html>.

In order to streamline the web advertising process, such industry standards for graphics advertisements have evolved so that ads can be easily inserted into existing web pages. By developing ads in such standard formats, websites can easily add new, or interchange existing ads, in the site's web pages. Standardization has also allowed ad servers to be utilized and act as third party repositories for ads that will be placed in web pages throughout the web.

Unfortunately, as noted above, when standardized formats are implemented, a price is paid in form of limited creativity. This is becoming a major issue on the web as users' eyes become trained to avoid looking at content that appears in a standard format (e.g., a banner ad). One solution for banner ads has been to animate the GIF images, which significantly raises the production cost for an ad. While animated images have been met with some success, restrictions on file size greatly limit the types of enhancements that can be implemented. Moreover, because banner ad developers are faced with such limitations, most animated ads have begun to take on a common appearance that does little to capture the attention of an end user. Accordingly, systems for enhancing content, particularly when such content is limited to standardized formats, are needed.

In addition, there are also many instances on the web where there is no distinction between advertiser and publisher. In many cases, companies use their internet presence in part to brand their products, with no expectation of direct revenue. One such example is the incorporation of branding into games. Unfortunately, creating games with branding images requires significant customization. Accordingly, it would be useful to be able to create brand intensive games without such customization.

### SUMMARY OF THE INVENTION

The present invention addresses the abovementioned problems by providing, in a first aspect, a system for enhancing a content object, comprising: (1) a system for downloading a network resource from a host server to a client; (2) a system for downloading an enhancement mechanism with the network resource, wherein the enhancement mechanism includes: (a) a request/loading module for requesting and loading the content object from a content server to the client; and (b) an enhancement module for altering an output format of the content object.

In a second aspect, the invention provides an enhancement mechanism for enhancing content, comprising: a system for loading a content object, wherein the content object comprises data stored in a predefined format; an enhancement module selected from a plurality of enhancement modules, wherein each enhancement module causes a unique alteration of the loaded content object; and an application programming interface for converting the data from the predefined format to a format compatible with the selected enhancement module.

In a third aspect, the invention provides a program product stored on a recordable media that, when executed by a server, comprises: (1) means for selecting an enhancement module from a plurality of enhancement modules; (2) means for installing an enhancement mechanism into a requested web page that is to be downloaded to a client, wherein the enhancement mechanism includes the selected enhancement module; and (3) proxy means for retrieving a content object on behalf of the client and causing the content object to be passed to the client.

In a fourth aspect, the invention provides a method of enhancing content, comprising the steps of: requesting a resource; retrieving and processing the resource, wherein the resource includes an enhancement mechanism; and processing the enhancement mechanism, including the steps of: (a) retrieving a content object; (b) transferring data from the content object to an enhancement module; and (c) executing the enhancement module such that the data from the content object is presented in an enhanced format.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of a network environment in accordance with a preferred embodiment of the present invention.

FIG. 2 depicts an enhancement mechanism in accordance with the present invention.

FIG. 3 depicts a flow diagram in accordance with the present invention.

FIG. 4 depicts a real time content enhancement system in accordance with the present invention.

FIG. 5 depicts a network environment using a third-party ad server in accordance with the present invention.

FIG. 6 depicts a chart showing banner ad usage by size.

FIGS. 7-13 depict various versions of games in accordance with the invention.

FIGS. 14-18 depict various cases for implementing an ad server in accordance with the invention.

FIGS. 19-21 depict various examples of an informing enhancement in accordance with the present invention.

### DETAILED DESCRIPTION OF THE INVENTION

### I. Overview

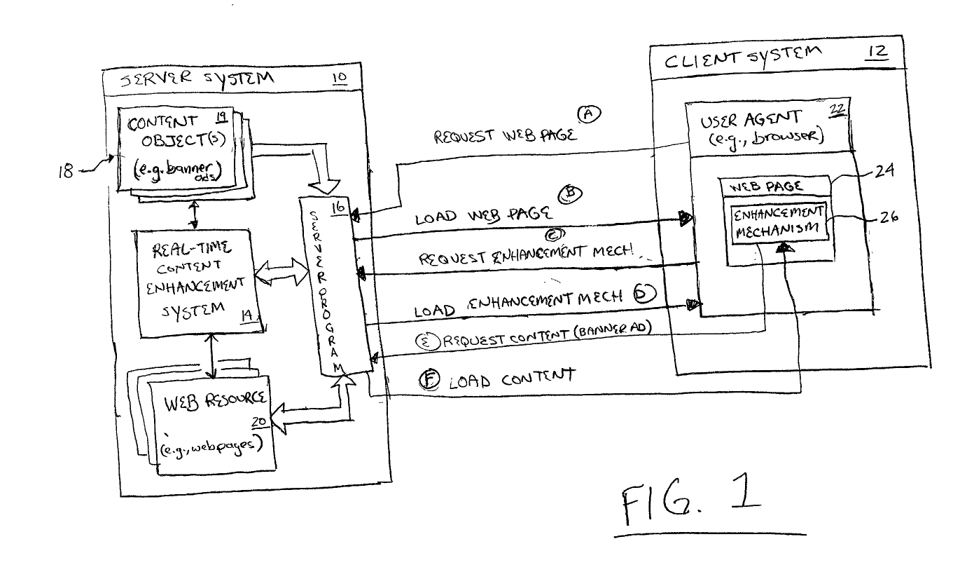

Referring now to the figures, FIG. 1 depicts a typical client server environment in accordance with the present invention. The environment comprises a server system 10, such as a web server typically found on the worldwide web, and a client system 12, that is capable of communicating with and exchanging information with server system 10. Server system 10 includes a server program 16 for delivering web resources 20 to client system 12. A web resource 20 may comprise any type of object, data, program, etc., that can be requested and served to client system 12. In an exemplary embodiment described herein, the web resource is a web page. However, it is understood that when the term web page is referred to herein, it can be replaced with any type of web resource without departing form the spirit and scope of the invention.

In addition, server system 10 includes a real time content enhancement system (RCES) 14 that can be utilized to enhance content 18 that is served to client system 12. Content 18 comprises one or more content objects 19, and may include any type of information typically displayed or output over the web. In general, content 18 comprises objects that reside and are served separately from the web (i.e., network) resources 20. In the exemplary embodiment described herein, content 18 is comprised of banner ads and the web resources 20 comprise web pages. Although the example involving banner ads is used throughout this disclosure, it is understood that the invention is not necessarily limited to banner ads, and any reference to banner ads can be substituted with any other type of content, or content objects, without departing from the scope and spirit of this invention. In addition, while content 18 is shown residing within server system 10, it is understood that content 18 can also reside elsewhere, e.g., on a third party server, in a local external database, etc.

In addition, the terms enhance and enhancement, as used herein, include any type of modification, addition, deletion, or alteration to content, and are not therefore limited to any subjective criteria regarding whether or not the object is actually improved. Moreover, an enhancement of content can include perceived alterations that do not directly change a content object, but rather change the context of the content object such that the object is perceived to have changed from a user's perspective. Further, the enhancement may comprise audio, video, or image alterations.

Client system 12 is shown comprising a user agent 22. In its most typical form, user agent 22 comprises a browser, such as Netscape® or Internet Explorer®. Nonetheless, it is understood that user agent 22 may comprise any other type of program that can access resources on behalf of a user or other entity. Accordingly, while the term ‘browser’ is used throughout this disclosure, it is understood that it could be substituted with any type of other user agent 22 without departing from the spirit and scope of this invention.

In operation, user agent, hereinafter browser, 22 requests a web resource, hereinafter web page, (A) from server program 16. Server program 16 then transfers the requested web page 24 back to the client system (B) where it is loaded by browser 22. Contained in web page 24 is request (C) for an enhancement mechanism 26. While in this exemplary embodiment, enhancement mechanism 26 is shown contained in web page 24, it is understood that enhancement mechanism could reside in whole or in part on server system 10. Enhancement mechanism 26, which is described in more detail below, is served (D) to the client/web page 24 via RCES 14 to retrieve, enhance and to display, play or present a content object 19. Enhancement mechanism 26 may have been inserted as a replacement to an existing standard HTTP (hypertext transfer protocol) call to content object 19. After web page 24 is loaded, browser 22 examines the HTML (hypertext markup language) code that forms the web page in order to turn it into a viewable resource for an end user. When the browser 22 reaches the enhancement mechanism 26, the enhancement mechanism 26 requests (E) content object 19 (e.g., a banner ad) from server system 10. Once server system 10 receives the request, server program 16 identifies the requested content and transfers (F) content object 19 back to browser 22. Next, the enhancement mechanism causes content object 19 to be displayed in an enhanced format. In one preferred exemplary embodiment described herein, the enhanced format is an interactive game comprised of the graphical data from content object 19 that was served to the client system. Accordingly, under the present invention, rather than just serving a requested content object to a web page, the present invention serves an enhancement mechanism 26 that will: (1) cause a content object to be requested; (2) load the content object; and (3) enhance the content object.

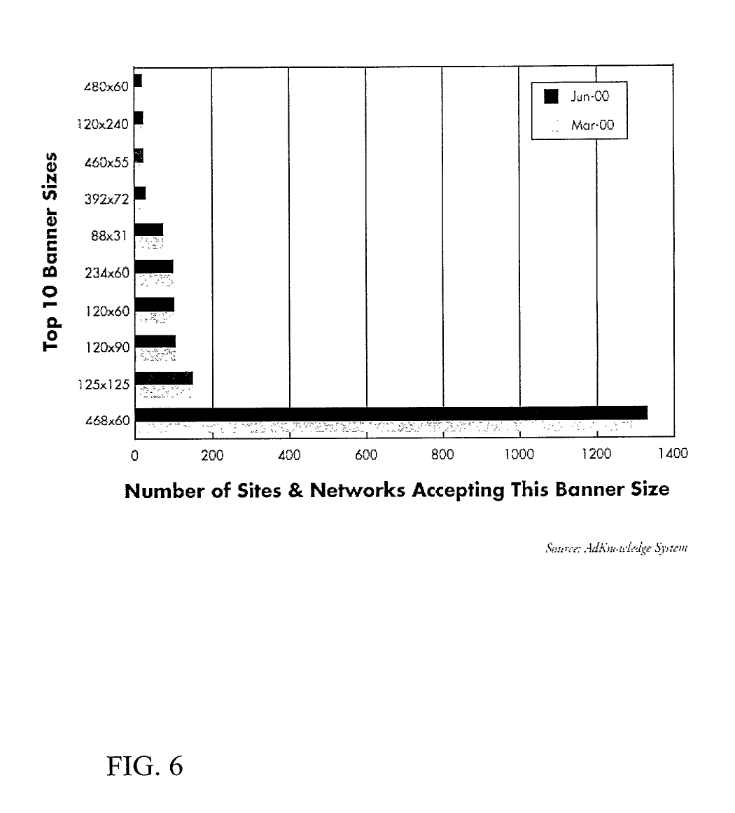

In one exemplary embodiment, content 18 may comprise content objects that are of a standard format. For example, banner ads and other forms of advertising, generally come in a standard size and format, such as 468 pixels wide by 60 pixels high. Smaller sizes include 125 by 125 and 120 by 90 pixels. These and other banner sizes have been established as standard sizes by the Internet Advertising Bureau (IAB). FIG. 6 depicts a sampling of different sizes for banner ads that are commonly found on the internet as reported by Adknowledge™ at <www.adknowledge.com>. It should be recognized however, that the present invention is able to enhance banner ads (or any other content) of any dimension, including standard banner ad sizes, in real time at the client system 12, thereby providing a seamless solution for banner ads being served from ad servers. In this context, “real time” refers to the fact that the content object can be altered by the RCES without prior adjustment, customization, or any other preparation of the content object for its use by the RCES. The RCES can also enhance content in “real-time” in the sense that the RCES does not have to be alerted as to the specifics of the content being inputted, but rather can interpret the content and then enhance it on-the-fly.

It should also be appreciated that the real-time content enhancement system (RCES) 14 of the present invention can be implemented as a stand-alone system (e.g., on a personal computer), and need not be implemented over a network. Thus, for example, RCES 14 could be implemented as a software program that, for example, imports a content object (e.g., an image) from a local storage and outputs an enhanced content object (e.g., a game that incorporates the image) on the local system. Accordingly, the present invention can be implemented in any interactive environment, including both network environments and stand-alone environments. In addition, it should be understood that while RCES 14 can convert content into enhanced content in real time, the enhanced content itself need not be actually displayed or used in real time, i.e., it can be stored and used at a later time.

It is understood that the various devices, mechanisms, modules and systems described herein may be realized in hardware, software, or a combination of hardware and software. They may be implemented by any type of computer system—or other apparatus adapted for carrying out the methods described herein. A typical combination of hardware and software could be a general purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

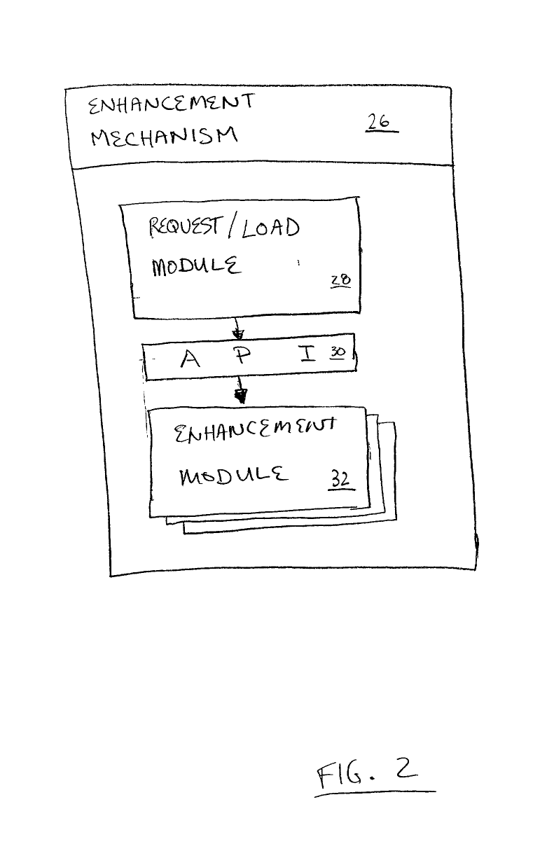

Referring now to FIG. 2, enhancement mechanism 26 is shown in greater detail. Enhancement mechanism 26 comprises a request/load module 28, an application programming interface (API) 30 and an enhancement module 32. Request/load module 28 is responsible for requesting content from the server, e.g., a banner ad, and then loading the content. Once loaded, the information associated with the content, typically graphics data, is passed through API 30 to enhancement module 32. Because a standardized API 30 is utilized in the enhancement module, any number of different types of enhancement modules 32 can be utilized. Accordingly, for example, a banner ad can be loaded and enhanced in one of many different ways. In a preferred exemplary embodiment, RCES 14 selects the enhancement module 32 that will be downloaded as part of enhancement mechanism 26. As an example, the enhancement modules may comprise different game applets that can allow an end user to interact and play with a banner ad integrated into a game. While the request/load module 28 and enhancement module 32 are preferably implemented as Java-type applets, it is understood that these modules can be implemented in any format by those skilled in the art in the present or future. A Java applet is a computer program written in the Java language intended to run embedded in a web browser. The Java Virtual Machine (VM) is that component of the web browser that is responsible for executing java applets.

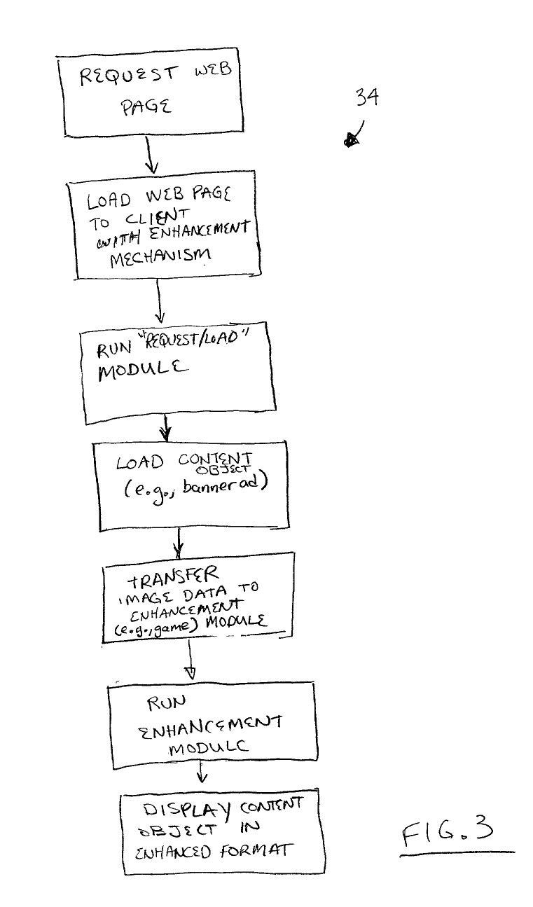

FIG. 3 shows a sample methodology of the above-described system 34. First, a web page is requested by a client system. Next, a web page is loaded onto the client system with an enhancement mechanism. Then the request/loading module of the enhancement mechanism is run. Next, the above module causes a content object to be loaded into the module. Next, content data is transferred to an enhancement module. Finally, the enhancement module is run displaying the content object in an enhanced format.

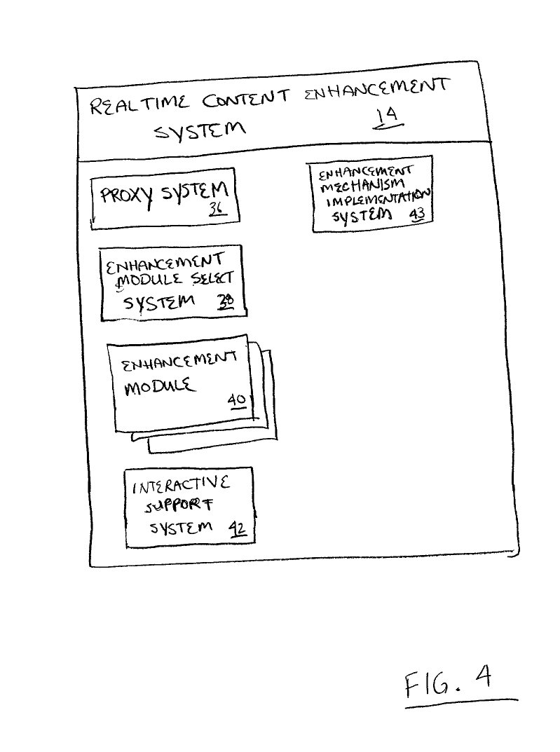

Referring now to FIG. 4, real time content enhancement system (RCES) 14 is shown in detail. RCES 14 comprises a proxy system 36, an enhancement module selection system 38, a plurality of enhancement modules 40, an enhancement mechanism implementation system 43, and an interactive support system 42. Proxy system 36 is described in further detail below, but in general provides a mechanism by which a host server can act as a proxy to handle the transfer of content from third party servers to the client. Enhancement module selection system 38 provides a system by which a particular enhancement module 40 can be selected for inclusion into enhancement mechanism 26. For example, the host server could decide to load a particular game based on the demographics of the user downloading the web page.

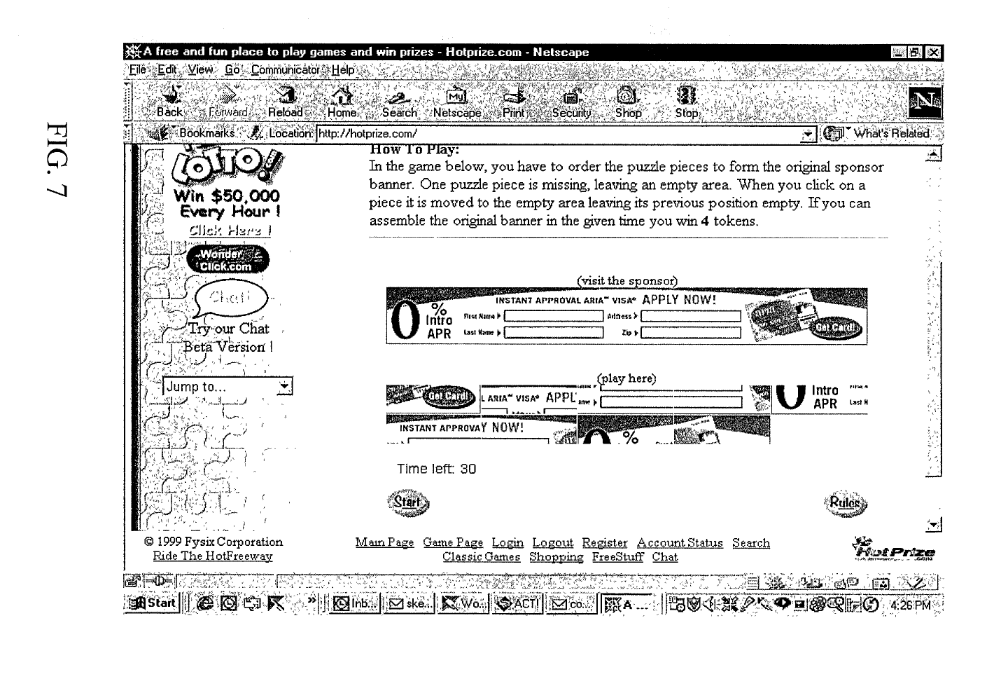

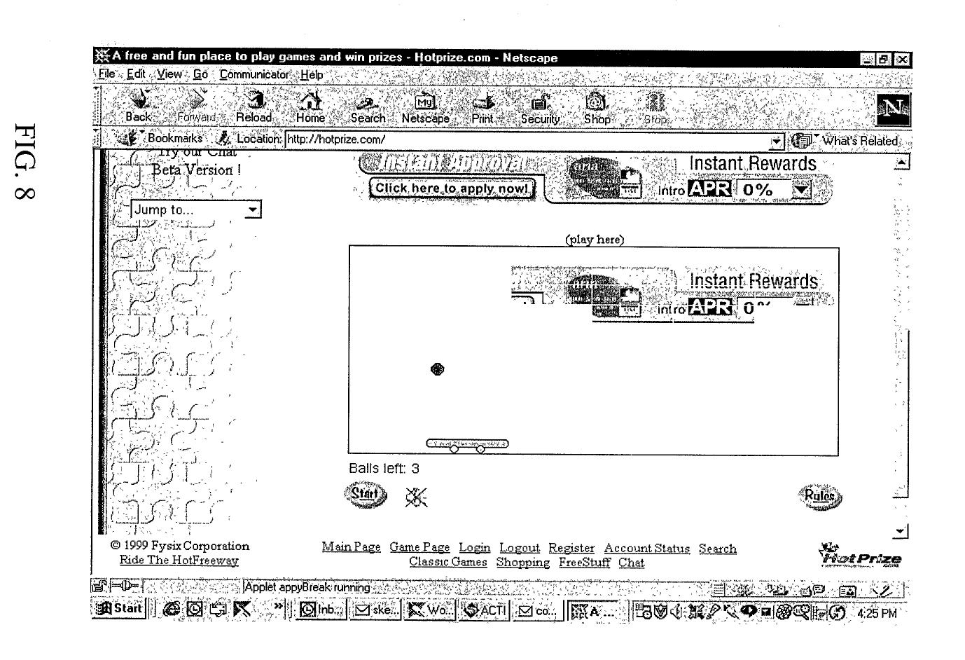

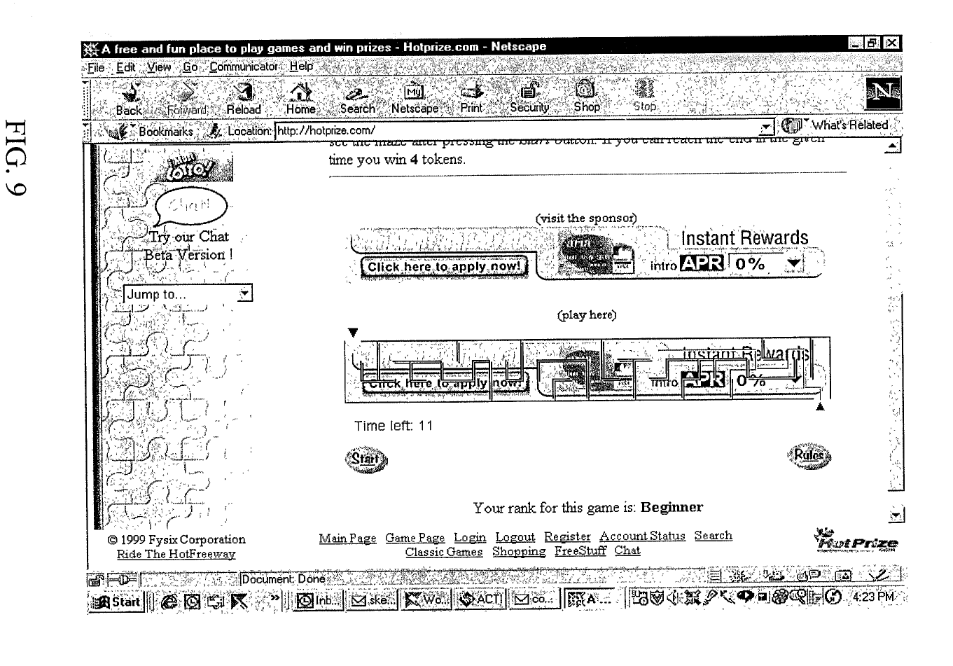

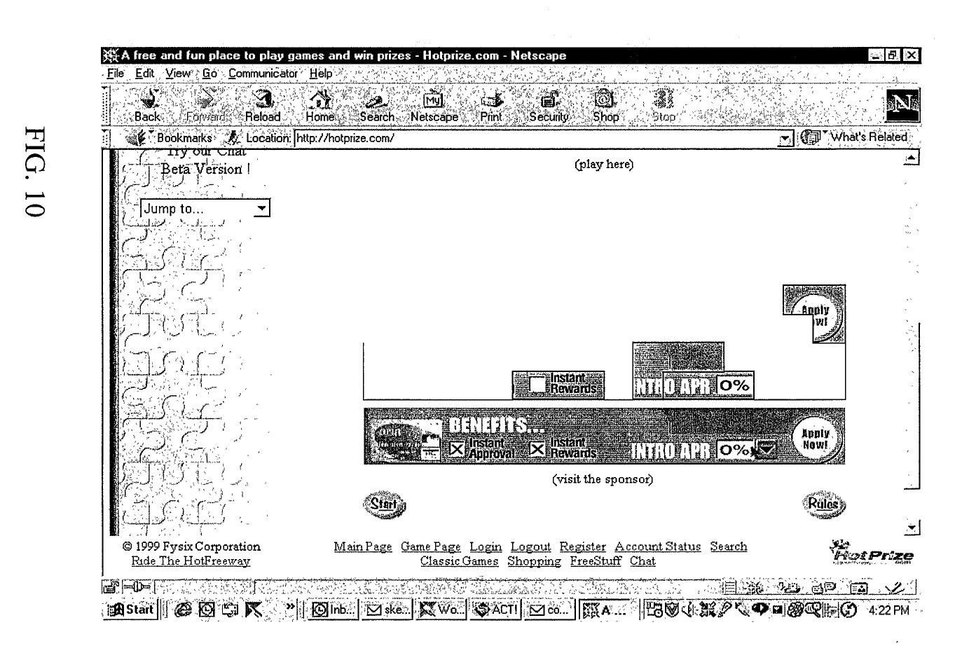

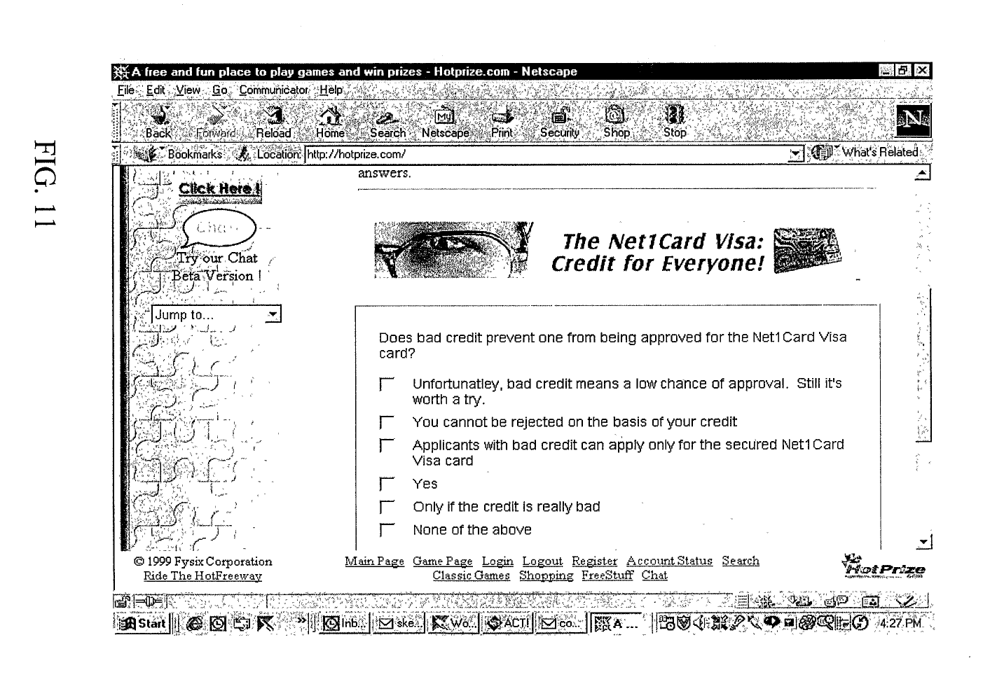

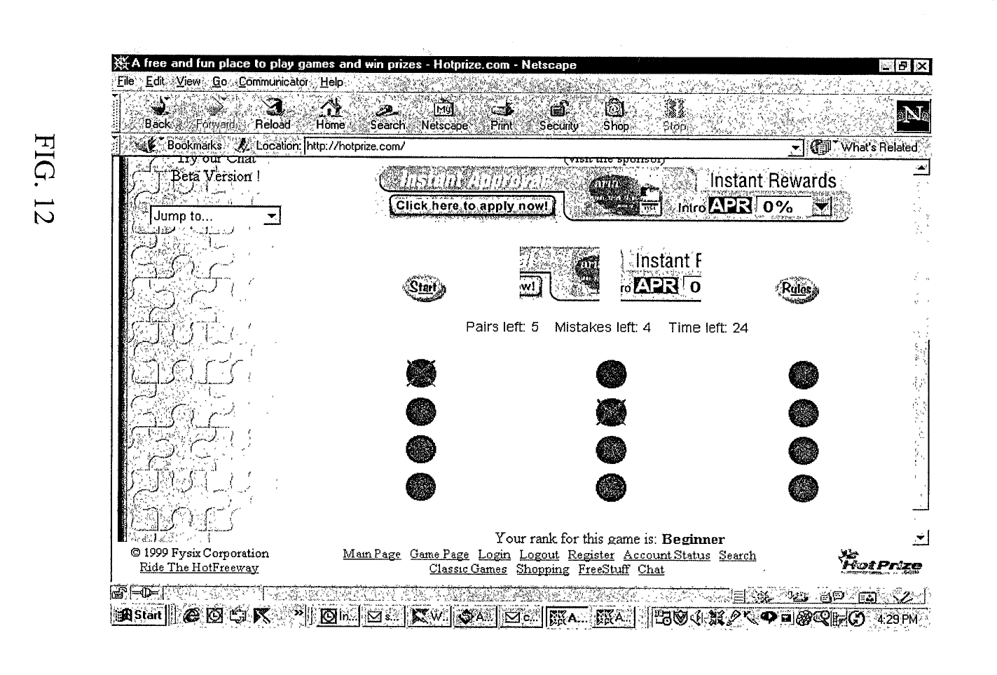

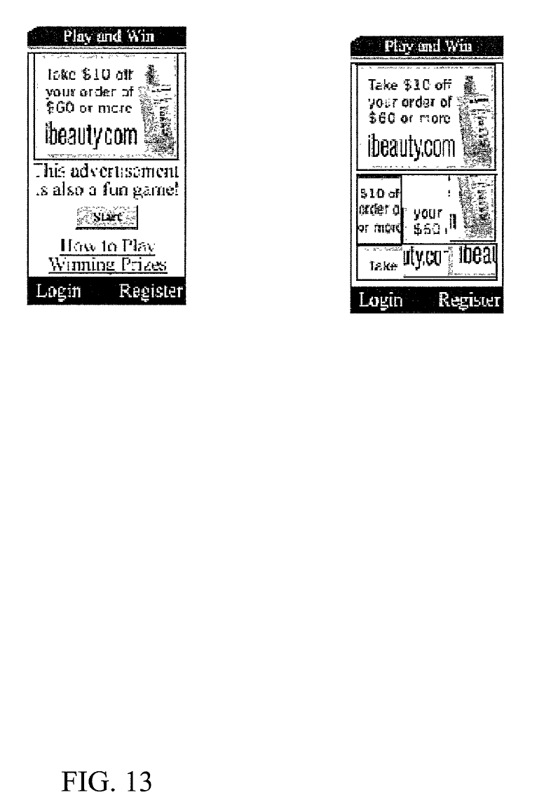

Enhancement modules 40, as described above, provide a predetermined type of enhancement to a content object requested by a web page. Different types of object enhancements that provide a gaming feature are shown in FIGS. 7-13. In particular, the examples convert banner ads (i.e., content) into games (enhanced content). For instance, FIG. 7 depicts a game entitled JIGSAW, in which a banner ad is scrambled 50, and the user must reorder the puzzle pieces to form the original banner 51. This comprises a first type of game wherein the banner ad is “scrambled,” and the game is essentially played within the banner ad space. FIG. 8 depicts BREAKOUT, in which the banner is comprised of a plurality of bricks that are removed when a ball hits a brick. Here the banner ad is dismantled during game play, and a portion of the game play exists outside of the banner ad. FIG. 9 depicts MAZE, which provides a maze overlaying a banner ad. Here the banner ad is more or less kept intact, with the game superimposed on the surface. FIG. 10 depict BETRIS, in which blocks forming pieces of a banner ad are manipulated as they are dropped. FIG. 11 depicts BANNER TRIVIA, in which trivia questions associated with the banner are displayed along with the banner ad. In this case, the game is ancillary to the banner ad, which remains intact. FIG. 12 depicts MATCH GAME in which each of the dots represent portions of a banner ad that must be matched. FIG. 13 depicts a second JIGSAW game in which a different sized banner ad is used. These games are displayed at <www.hotprize.com> which is hereby incorporated by reference. For each of the games, tokens may be awarded for successfully completing a game, and later redeemed for prizes, (e.g., using a prize wheel).

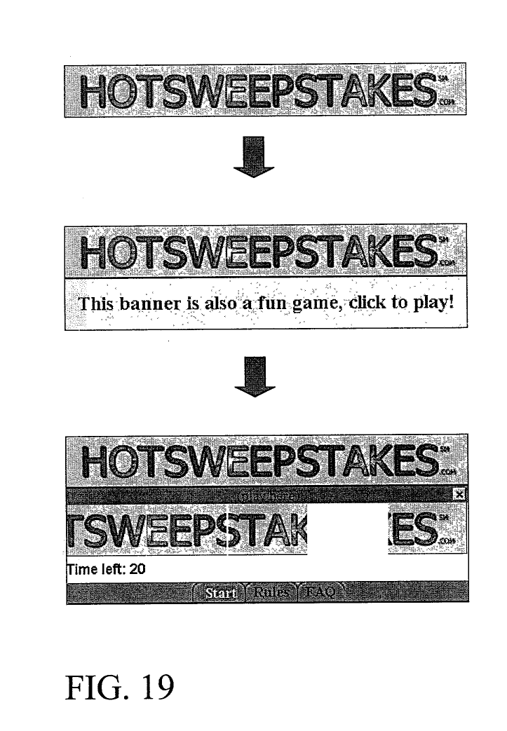

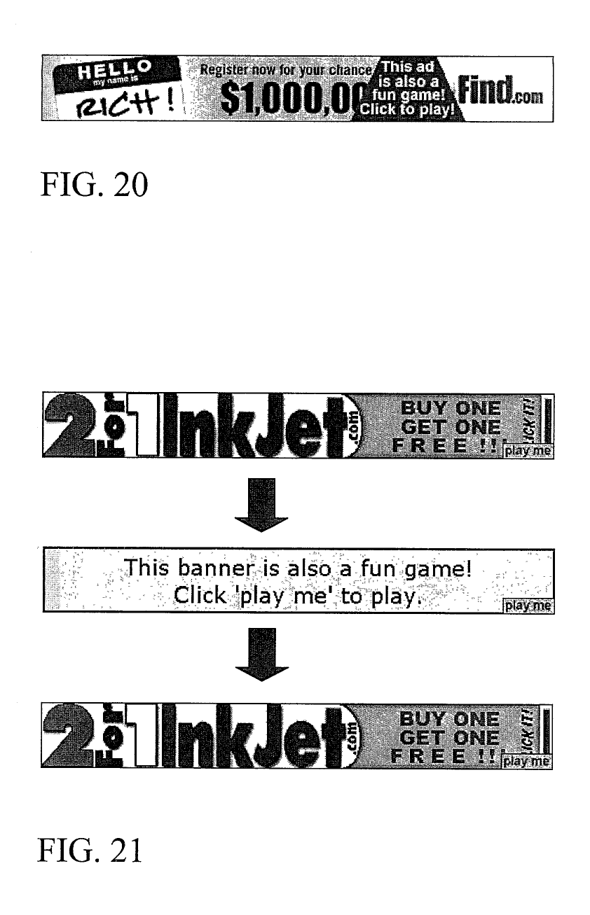

Another category of enhancement involves providing an “informing enhancement,” in which content is altered (e.g., with a message) in such a way as to inform the user that the content can be further altered (e.g, converted into a game). Examples of content having an informing function that request a user action are shown in FIGS. 19-21. For example, in FIG. 19, a regular banner ad (top image) is enhanced with an informing enhancement that is appended to the banner ad (middle image) that allows the user to convert the banner ad into a jigsaw game (bottom image). In FIG. 20, the informing enhancement is dynamically overlaid on top of the original banner ad. In FIG. 21, the original content (top and bottom image) is periodically interrupted with the informing enhancement (middle image). It should be recognized that the informing enhancements described herein are for exemplary purposes only.

Enhancement mechanism implementation system 43 provides a system for installing the enhancement mechanism 26 into a downloaded web page. In a preferred embodiment, the enhancement mechanism 26 comprises one or more java applets that replace an embedded ad (e.g., a call to an address where a banner ad is stored). This is described in more detail below.

Interactive support system 42 provides a mechanism for allowing certain functional aspects of the enhancement mechanism 26 to reside on the host server system to provide greater interactive support. Thus, for example, the enhanced content may have access to routines that reside back on the host server system. This could provide such functionality as an interactive banner game that allows players across the web to interact with each other during game play.

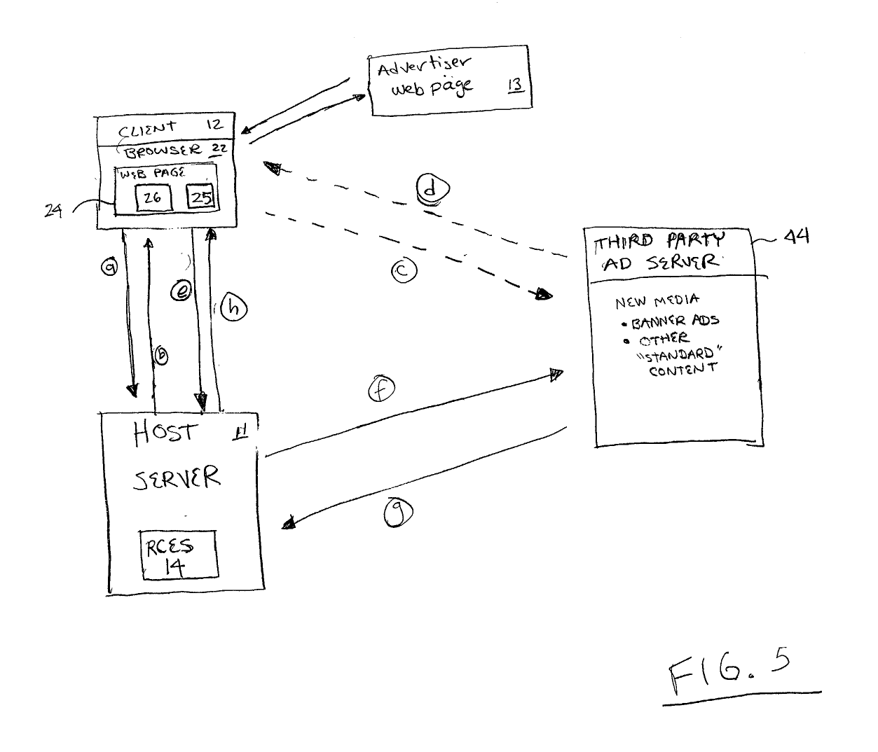

FIG. 5 shows a typical web environment where a third party content server, “ad server” 44 is utilized. As described above, ad servers are commonly used on the web to store banner ads and to allow a third party system to handle the selection of an ad from several ad campaigns. In a typical known art application, banner ads are often served and retrieved in the following manner. First, client 12 requests a web page from server 10 (a) which returns a web page back to the client (b). As the browser 22 analyzes the returned web page, it may often come across a request for a banner ad, that contains a location, for example a URL or web address in which the banner ad can be found. Accordingly, a request (c) would be sent to the third party ad server 44 which would then serve the banner ad back to the client (d) which would cause the ad 25 to appear in the selected web page 24. In addition the ad server may have to redirect the user agent to the advertisers web page 13 when the user clicks the ad 25.

Unfortunately, due to restrictions imposed in the Java programming environment, this architecture would not allow banner ad enhancements to be implemented as Java applets using the above described methodologies. In particular, in the Java environment, a Java applet is, by default, only allowed to engage in network communication with the same server where the applet was downloaded from. These restrictions are also found in similar technologies such as Macromedia®Inc.'s Flash®, and stem from security and privacy concerns for the end user. Therefore, if client 12 downloaded the enhancement mechanism 26 from host server, the applet could not cause an ad to be retrieved from a third party ad server 44.

One apparent solution would be to have the applet downloaded from the third party ad server 44 as opposed to the host server 11. However, this solution introduces numerous limitations. In particular, one of the advantages of the present invention is to allow standard content, such as banner ads and the like, to be accessed and enhanced, without having to provide any modifications to the sources of the standard content.

Accordingly, to overcome the Java limitation, the present invention may utilize a proxy system that is part of the RCES located on host server 11. The implementation is described as follows. First, (a) client system 12 requests a web page from host server 11. Host server 11 then returns the web page 24 to client 12 embedding the enhancement mechanism 26 (b). Then, when the enhancement mechanism is executed by browser 22, rather than looking directly to the third party ad server 44, the enhancement mechanism in the web page requests the banner ad (e) from host server 11 using a specific URL format. Host server 11 then interprets the request and goes off to third party server 44 to obtain the banner ad (f). The banner ad is then returned (g) directly to host server 11, and then is returned (h) to client system 12, where it is loaded, enhanced and displayed in web page 24 by browser 22. Because all of the communication with client system is directed through host server 11, the downloaded Java applets are unrestricted.

In order to implement the proxy system 36 as described above, the enhancement mechanism implementation system 43 (FIG. 4) must modify the address of the banner ad in the retrieve/load module of the enhancement mechanism so that browser 22 does not request the banner ad directly from the ad server 44. One solution for this is to alter the URL of the banner ad so that it now points to the host server 11, but includes details of where the banner ad is located. Thus, for example, if the URL for the banner ad was <http://www.adserver.com/ad.1> then the new URL could be changed to: <http://www.hostserver.com/p/www.adserver.com/ad.1> where www.hostserver.com refers to the address of host server 11. Then, when host server 11 received the request, proxy system 36 contained in RCES14 would send a request to <http://www.adserver.com/ad.1> to retrieve the banner ad back to host server 11. Proxy system 36 would then forward the banner ad to client system 12.

While the proxy loading system is required for loading the banner ad from an arbitrary location, it is not required if all banner ads are located on the host server. Thus, for example, a third party ad serving company would not require the proxy loading system for applying this invention to its own banners, since those banners could be located on the same server as the RCES.

A more detailed description of this proxy system is provided below.

### II. Proxy Ad Loading System

A. Glossary of Terms Used:

Ad: Banner Ad or other content

Ad URL: The uniform resource locator that is used by the user agent to retrieve the ad. This URL does not necessarily point directly to the ad, but may result in redirects to the ad. Click URL: The URL that is used by the user agent to access a destination document upon user action to the ad. This action may be a click. Similar to the ad URL, the click URL does not necessarily point directly to destination document, but may result in redirects to it. Destination document: The document that should be loaded upon user action to the ad. Redirect: A response by a server, e.g. using the HTTP protocol, that indicates to the user agent to look for the requested resource at a different location (URL). The user agent will then retrieve the resource from that location, usually without interaction with the user.

B. Description

The ad is specified with a uniform resource locator (URL), referred to as ‘ad URL’. This URL points to a network location that either contains the static ad, statically or dynamically redirects the request to a different location, or returns an ad content that is dynamically generated, i.e. may change each time the ad is requested. Part of the ad is usually a link (URL) pointing to a destination document that should be loaded upon user action (click), referred to as ‘click URL’. This URL, similar to the ad URL, can point directly to the destination document, or can result in a redirect chain to the destination document. (Technical note: ‘redirect’ refers to a 30×HTTP response that instructs the user agent, e.g. web browser, to look for the desired entity at a different location, which is specified as part of the response. ‘Redirect chain’0 refers to multiple redirect responses before the final location is encountered.)

Typical third party ad serving technology commonly uses two popular mechanisms for ad delivery. The first mechanism delivers an ad document to the user agent that contains one or more objects, or URLs to those objects, that represent the ad, possibly including one or more links to documents that should be loaded by the user agent upon specific user actions as defined in the ad document. (e.g. an HTML document for an IFRAME that embeds a rich media ad).

The second mechanism consists of distinct URLs for an ad object (image) and a destination document. This second mechanism commonly uses a redirect mechanism for the ad URL and the click URL. The ad URL and click URL given to the user agent will, when accessed, result in a redirect chain to a different location. This redirect mechanism enables the third party ad server, to independently chose in real-time which ad the user agent should load. At this point it is only known to the third party ad serving system what the correct final URL for the destination document is. If, due to user action, the click URL is requested, the user agent will be redirected by the ad server to the destination document that matches the ad that was previously requested by that user agent. Since many different user agents may request ads simultaneously from the third party ad serving system, this system must employ a mechanism to match a request to a click URL from a specific user agent with the previous request to the corresponding ad URL that was requested by the same user agent.

As part of this matching mechanism the numerical network address (IP address) of the user agent is commonly used. The IP address of the user agent that accesses a click URL is matched (full or in part) against IP addresses from past requests to ad URLs. If a match is made and other parameters of the request are matched as well, the previously delivered ad can be determined and the URL of the corresponding destination document is returned to the user agent in form of a redirect.

The real time ad loading system is able to load any ad or other content, which is delivered by any of the above mechanisms, including third party ad serving.

In order to be compatible with currently wide spread technology, an implementation of the ad loading system with the programming language Java, which runs on a web-browser as Java Applet, is described. However, is should be understood that the present invention is not limited to Java, and could be implemented, for example, with Macromedia Inc.'s Flash™ technologies, as a browser add-on or plug-in, etc.

A Java applet is a computer program that is usually loaded over a network with a web browser and runs embedded in that browser. Due to security issues with remotely loaded software, the Java technology imposes a set of restrictions on the abilities of a Java applet. Due to these restrictions a Java applet is, by default, only allowed to engage in network communication with the same server where the applet was downloaded from. This server will be referred to as ‘origin server’. (In more detail, the applet can only communicate with a server that has the same network name or domain name as the origin server, which is not necessarily the same server as the origin server. Note that there is no origin server restriction for the java applet, when instructing the user agent, or web browser, to load a new document on behalf of the applet. The restriction only applies when an object is loaded as data into the applet.) These network restrictions can be lifted when the user specifically grants extended privileges to this java applet.

A possible solution for loading an ad with unrestricted URL, with and without lifting the network communication restrictions is described as follows. The URLs for one or more ad documents or one or more ad objects (images) and one or more destination documents are dynamically or statically embedded in the document that contains the ad loading java applet, such that the applet can read those URLs.

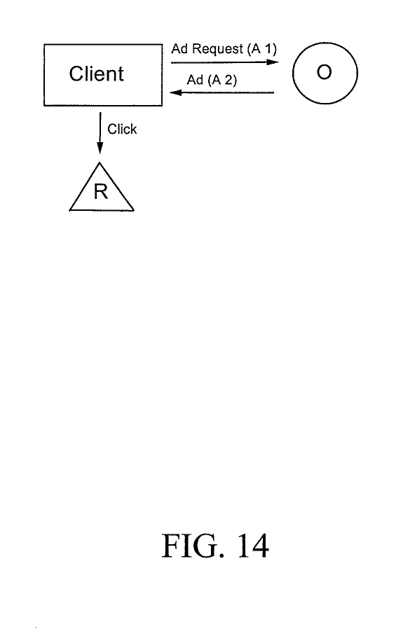

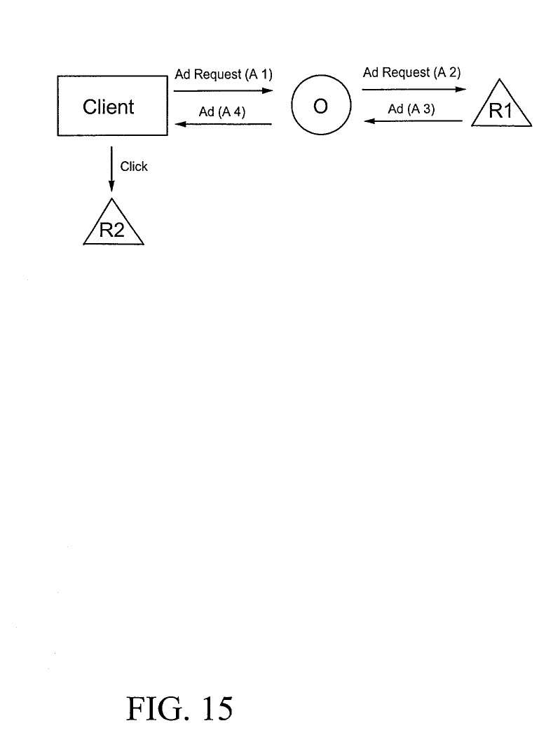

Referring now to FIGS. 14-18, six exemplary cases for serving content pursuant to the present invention are described. In the case shown in FIG. 14, the ad object (image) is located on the origin server O. R is the remote server that hosts the destination document when the ad is clicked. In the second case shown in FIG. 15, the ad is located on a remote (none origin) server (R1), click destination is known (R2). R1 and R2 may or may not be the same server.

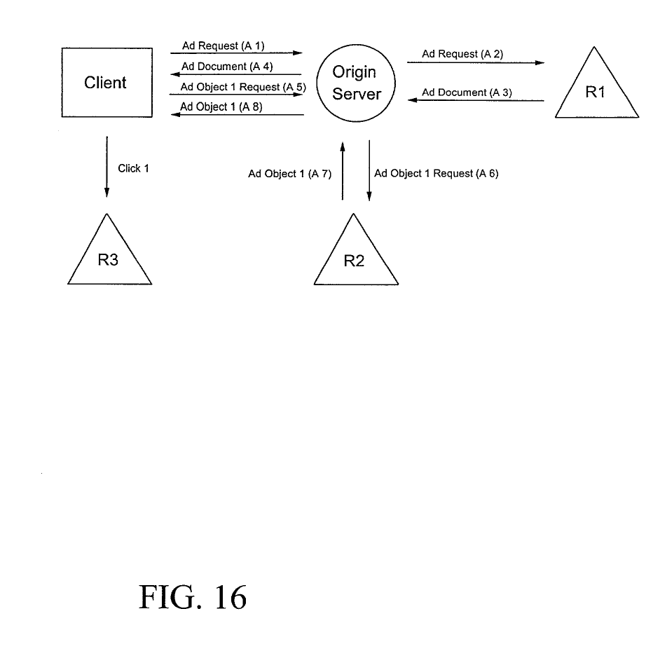

In the third case shown in FIG. 16, an ad serving system that delivers an ad document (e.g. DoubleClick's DART® system) is used. Involved entities are the Client, the Origin Server and up to 3 or more remote servers R1, R2 and R3. In the general case R1, R2 and R3 are distinct but this is not necessarily the case. The requests for the ad document and any ad objects are directed to the origin server, which will retrieve the entities, possibly resolving several redirects through additional remote servers, and return them to the client. The client applet uses the ad object(s) to assemble the ad. Upon user action the client can load a destination document, directly or through redirects, from remote server R3.

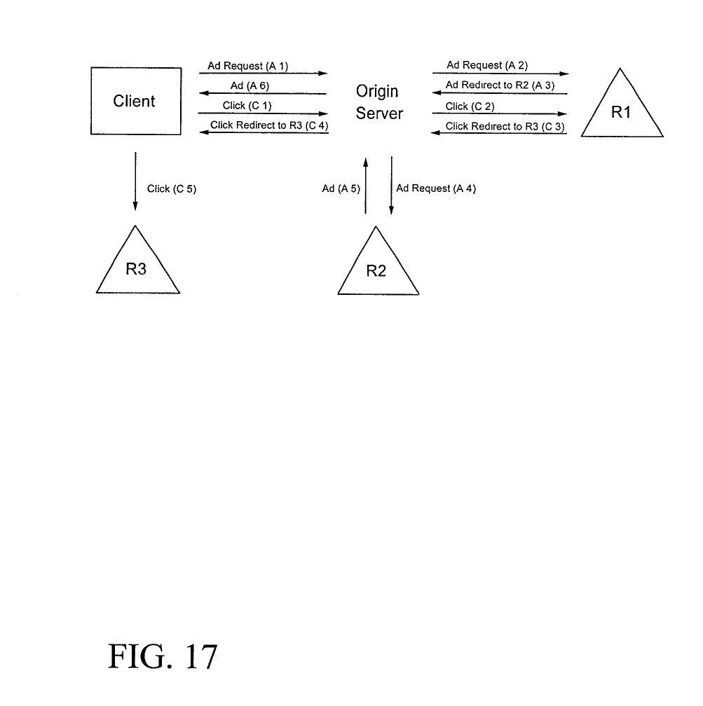

In the fourth case shown in FIG. 17, an ad serving system that uses a distinct ad URL and click URL which are mapped onto an ad object (image) and a destination document, respectively using HTTP redirects (e.g. like DoubleClick's DART system). Involved entities are the Client, the Origin Server and up to 3 remote servers R1, R2 and R3. In the general case R1, R2 and R3 are distinct but this is not necessarily the case. There are 2 event chains, one for the ad retrieval (A1 through A6) and one for the click action (C1 through C5). As described above, in this case a request to the click URL must be matched with a previous request to the ad URL by the same user agent, in order to map the click URL with the correct destination document that corresponds to the previously delivered ad. Since the matching mechanism, commonly used by third part ad serving systems, relies on the origin IP addresses of both requests (ad and click), both requests must be received from the same origin. Hence if the ad request received by the ad serving system came from the origin server, the click request must also come from the origin server and not directly from the client. Therefore in this case the origin server serves not only as a proxy for ad objects, but also for clicks up to the first redirect. (Note: proxy does not mean HTTP proxy as defined by the HTTP standard, but rather describes the proxy mechanism described before.)

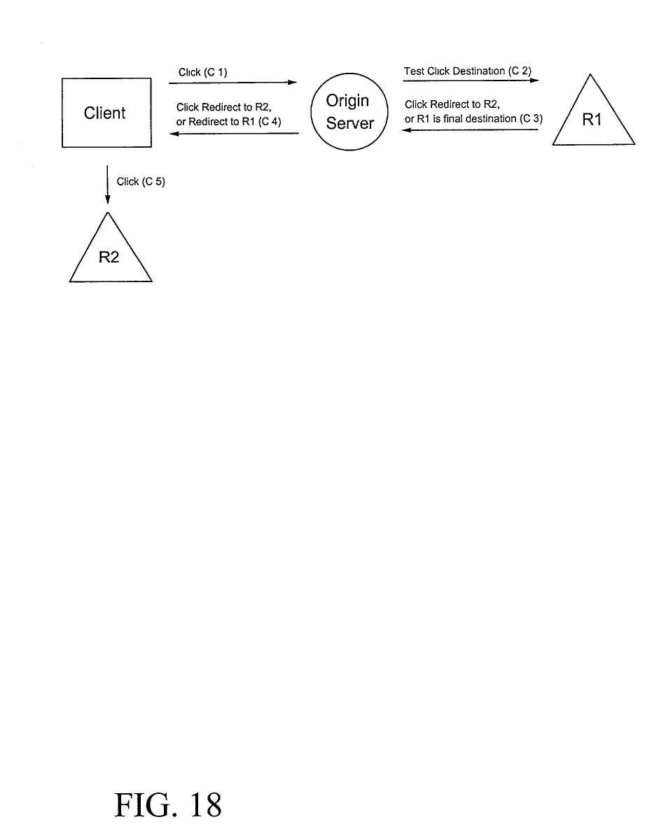

A fifth case is shown in FIG. 18. It is unknown in real-time, by which of the previous cases the ad must be handled. This does not affect the ad request, since the client sends the ad request in all cases to the origin server. The origin server can retrieve the ad either from the local system or from a remote system through 0 or more redirects. In order to cover the case that a third party ad serving system is in use that needs to match a click URL with the ad URL, the click request must be send to the origin server which will then send it to the remote server. An ad serving system will then be able to make a correct match using the origin IP of the click request.

The origin server will access the remote destination of the click request in order to determine whether a redirect is returned (possibly by an ad serving system) or if the click destination points directly to the destination document. This could be tested e.g. with a HTTP HEAD request, if that type of request is honored, otherwise one can use a conventional GET request. If a redirect is returned, that redirect is forwarded to the client. If the click destination is the final destination, a redirect message to that destination is created and then returned to the client.

In a sixth case, network I/O is not restricted. Without restriction on the network communication abilities of a java applet all involved resources can be loaded directly from the java applet.

After loading the ad, it is modified into an internal format for visual display. In this internal format the ad can be used directly for display or as part of an interactive game, and in addition the ad can be transferred to other Java applets using a predefined application program interface (API). Other applets can then use the ad as part of an interactive game or for any other enhancements. New games or enhancements can be added that only need to implement the predefined API in order to be able to access an ad.

### III. ADDITIONAL DETAILS RELATING TO THE ENHANCEMENT MECHANISM

While an implementation of the preferred embodiment is possible with several available technologies, one of the most widespread is Java. Accordingly, the following provides details of an implementation using this technology.

Since all enhancement modules (e.g., game enhancements) use of the same loading mechanism, they may be implemented as Java applets in a modular fashion. On every web page that contains an enhancement mechanism, there are two java applets, one that is responsible for retrieving the content object (e.g., banner ad), and another one that implements the enhancement. The applet that retrieves the content object is called the Image-Manager, and is described generically above as the generic load/retrieve module 28. The Image-Manager could also be represented as the super class of all enhancement modules in making use of an object oriented design strategy. In this case, the functionality offered by the Image Manager could be bundled with the enhancement into a single applet.

The Image-Manager has additional functionality besides retrieving the content object. It can also display the content object, and it implements the functionality that allows the user to, for example, ‘click’ the object (or use some other user action) in order to cause a destination document to be loaded by the browser. As noted above, the Image-Manager and the enhancement module share a common programming interface that allows the Image-Manager to, for example, transfer a retrieved ad to a game. Java technology allows several applets on one web page to communicate with each other. For the purposes of the description that follows, the content object will be described as a banner ad, or ad, and the enhancement module will be described as a game. It should however be recognized that this is for exemplary purposes only.

Some components of the ad, or the entire ad, may include an image that needs to be downloaded (using, for example, the proxy mechanism of the origin server described previously). The standard way in Java to download an image uses the Java function ‘getImage(URL url)’ (or getImage(URL url, String string) ). The getImage function takes the URL of the image and retrieves it. Due to problems with this standard Java function that are described next, an alternative mechanism is provided to download an image in the event that the standard getImage function could not be used.

The getImage function can result in multiple downloads of the image especially when the image is shared between the Image-Manager and the game. The Image-Manager may display the image in its unaltered form while the game modifies the image to create the game. Therefore, there are two java applets that use the same image. Due to the implementation of the getImage function in Java, it happens that when the second applet is accessing the image that was downloaded with the getImage function, a new download of that image is initiated instead of using the already downloaded data. When the ad is provided by a third party ad serving system, then the ad may be dynamically selected upon a request to the ad URL (as described previously). This will cause the second download from the image URL to retrieve a different image than was retrieved by the first download. Hence, the Image-Manager and the game would display different, independent images. This effect cannot be prevented when using the getImage function. (It is unclear why the getImage function behaves that way, but it has been observed with several implementations of the java technology. In addition it has been observed that even when the image is only used by one applet multiple downloads can occur when the applet inquires about image properties, such as width and height.)

Since many games require both versions of the ad, i.e., an unaltered version and a modified version, it is not possible to use the standard getImage function for image retrieval. Instead the following solution can be used. First, the image is downloaded as a data stream into a byte array. Next, an Image object is created from the ByteArrayImageSource using the createImage function. As of Java 1.1, the createImage function is able to create an image from a byte array. In order to be Java 1.0 compliant, one can first convert the byte array into a ByteArrayImageSource, which is an internally used data-structure in Java, and then convert it into an Image using createImage.

Since ByteArrayImageSource is not part of the public java API (Application Programming Interface), different implementations of the Java Virtual Machine (the component of the web browser that is responsible for executing a java applet) may have their own version of the ByteArrayImageSource class. In particular, while Netscape Navigator uses Sun's implementation (sun.awt.image.ByteArrayImageSource), Microsoft's Internet Explorer uses its own implementation (com.ms.awt.image.ByteArrayImageSource). The Image-Manager that makes use of this class therefore implements a solution that uses the particular ByteArrayImageSource object that is used by the platform the applet is running on.

With this approach multiple internal accesses to the image will just result in additional accesses to the data stored in the byte array and not in additional downloads.

### A. Extracting the first frame of a GIF movie

Many ads consist of a GIF movie. GIF is an image format developed by CompuServe that consists of several frames (images) that are displayed one after each other with given delay times. For many games it is not useful to use a movie instead of a static image. Therefore a mechanism is described using the Java technology that extracts the first frame of a GIF movie. (It is understood that the extraction of a subsequent frame, as opposed to the first could likewise be implemented without departing from the scope of this invention.)

The correct behavior of a GIF movie is entirely handled by the Java technology. Java is responsible for switching the frames in the given time intervals and no explicit programming of this functionality by the applet programmer is required. Therefore the default behavior of the Java Virtual Machine is to “run the GIF movie.” Programming is required for altering this behavior.

The Java technology allows implementation of so called Image Filters that can be used to alter an image. The extraction of the first frame of a GIF movie is implemented as such a filter. An Image Filter is an object that can ‘intercept’ or modify internal functions of the mechanism that is used by Java to create the visual representation of the image from the image data. The Java mechanism for creating the image representation consists of two main objects, namely the ImageProducer and the ImageConsumer. These two objects interact through function calls. The Image Filter can intercept those function calls, i.e., the ImageProducer would call the setHints function of the Image Filter, which in turn calls the setHints function of the ImageConsumer. Without an Image Filter, the ImageProducer would call the setImage function of the ImageConsumer directly. This mechanism enables the Image Filter to alter the information that is transferred between ImageProducer and ImageConsumer.

Two of the functions used for communication between ImageProducer and ImageConsumer need to be intercepted to extract the first frame from a movie. The source code of those functions is shown here:

```
public class FrameFilter extends ImageFilter {
    public void setHints(int hintflags) {
      consumer.setHints(hintflags & SINGLEFRAME);
    }
    public void imageComplete(int status) {
        if (status==SINGLEFRAMEDONE) {
          consumer.imageComplete(STATICIMAGEDONE);
        } else {
          consumer.imageComplete(status);
        }
    }
}
```

The setHints function gives some of the image properties to the java system. In the above implementation, all those properties are preserved and one property, the SINGLEFRAME property is added. This property indicates that the image consists of a single frame.

The imageComplete function indicates to the java system the current progress of the internal creation of the image representation. In case of a continuously looping movie, the internal creation is an ongoing process that never finishes until the termination of the program. One stage in the creation of a movie is the completion of an individual frame. When that stage is reached, the original imageComplete function will send the SINGLEFRAMEDONE status. The above implementation of the imageComplete function will send the STATICIMAGEDONE status when the representation of the first frame of a movie is completed. Thus, the system will only recognize the first frame of a GIF movie as a static, single frame image.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

We claim:

1. A system for enhancing a content object, comprising:
a system for downloading a network resource from a host server to a client;
a system for downloading an enhancement mechanism with the network resource, wherein the enhancement mechanism includes:
a loading module for requesting and loading the content object from a content server to the client; and
an enhancement module for altering an output format of the content object.

2. The system of claim 1, wherein the network resource is a web page.

3. The system of claim 2, wherein the content object is an ad.

4. The system of claim 3, wherein the ad comprises an ad in an industry standard format.

5. The system of claim 2, wherein the content object is an image.

6. The system of claim 2, wherein the enhancement mechanism comprises a plug-in embedded in the web page.

7. The system of claim 6, wherein the plug-in comprises an applet.

8. The system of claim 1, wherein the content server is an ad server.

9. The system of claim 8, wherein the ad server is a third party server.

10. The system of claim 8, wherein the host server acts as the ad server.

11. The system of claim 1, wherein the enhancement module converts the content object into a game.

12. The system of claim 3, wherein the enhancement module converts the ad into a game.

13. The system of claim 12, wherein the game overlays the ad.

14. The system of claim 12, wherein the game partitions the ad into a plurality of smaller images that can be manipulated by an end user.

15. The system of claim 12, wherein the game resides in an area outside of the ad.

16. The system of claim 1, wherein the enhancement module instructs the host server to retrieve the content object.

17. The system of claim 1, further comprising a proxy system that obtains the content object from the content server on behalf of the client.

18. The system of claim 2, wherein the enhanced content object is created by replacing an embedded ad with the embedded enhancement module.

19. The system of claim 1, wherein the enhancement module alters the output format of the content object by providing an informing enhancement that requests a user action.

20. The system of claim 1, wherein the content object is altered in real-time.

21. The system of claim 1, wherein the content object is loaded into the enhancement mechanism in one of a plurality of formats that do not require customization.

22. An enhancement mechanism for enhancing content, comprising:
a system for loading a content object, wherein the content object comprises data stored in a predefined format;
an enhancement module selected from a plurality of enhancement modules, wherein each enhancement module causes a unique alteration of the loaded content object; and
an application programming interface for converting the data from the predefined format to a format compatible with the selected enhancement module.

23. The enhancement mechanism of claim 22, wherein at least one of the enhancement modules converts the content object into a game.

24. The enhancement mechanism of claim 22, wherein at least one of the enhancement modules comprises an information enhancement.

25. The enhancement mechanism of claim 22, wherein the content object comprises an ad.

26. The enhancement mechanism of claim 22, wherein the system for loading the content object, the application programming interface, and the selected enhancement module are contained within a web page.

27. The enhancement mechanism of claim 22, wherein the system for loading the content object and at least one enhancement module are implemented as Java applets.

28. A program product stored on a recordable media that, when executed, comprises:
means for selecting an enhancement module from a plurality of enhancement modules;
means for installing an enhancement mechanism into a requested web page that is to be downloaded to a client, wherein the enhancement mechanism includes the selected enhancement module; and
proxy means for retrieving a content object on behalf of the client and causing the content object to be passed to the client.

29. The program product of claim 28, wherein at least one of the plurality of enhancement modules converts the content object into a game.

30. The program product of claim 29, wherein the content object is selected from the group consisting of: an ad or an image.

31. The program product of claim 28, wherein at least one of the plurality of enhancement modules appends an information enhancement to the content object.

32. The program product of claim 28, wherein the proxy means causes an address of the content object to be modified to point to an address of a host server.

33. A method of enhancing content, comprising the steps of:
requesting a resource;
retrieving and processing the resource, wherein the resource includes an enhancement mechanism; and
processing the enhancement mechanism, including the steps of:
retrieving a content object;
transferring data from the content object to an enhancement module; and
executing the enhancement module such that the data from the content object is presented in an enhanced format.

34. The method of claim 33, wherein the resource comprises a web page, and the resource is retrieved from a server.

35. The method of claim 33, wherein the content object comprises an ad.

36. The method of claim 33, wherein the content object comprises an image.

37. The method of claim 33, wherein the enhancement module converts the content object into a game.

38. The method of claim 33, wherein the enhancement module comprises an informing enhancement that appends a message to the content object that requests an action from an end user.

39. The method of claim 38, wherein the message is overlaid on top of the content object.

40. The method of claim 38, wherein the message is appended outside of the content object.

41. The method of claim 38, wherein the message is displayed intermittently with the content object.
